(19) United States
(12) Patent Application Publication
(10) Pub. No.: US 2008/0033957 A1
(43) Pub. Date: Feb. 7, 2008

(54) ELECTRONIC CALENDAR EVENTS DROP BOX

(76) Inventors: Scott Forstall, Mountain View, CA (US); Lala Dutta, Cupertine, CA (US); Cyrus Daboo, Pittsburgh, PA (US)

Correspondence Address: APPLE COMPUTER, INC./BLAKELY, 1279 OAKMEAD PARKWAY, SUNNYVALE, CA, 94085-4040, US

(21) Appl. No.: 11/760,777

(22) Filed: Jun. 10, 2007

Related U.S. Application Data
(60) Provisional application No. 60/835,510, filed on Aug. 4, 2006.

(51) Int. Cl. G06F 17/40; G06F 17/30; H04L 9/32

(52) U.S. Cl. 707/9; 707/104.1

(57) ABSTRACT

A meeting originator associates a file with a meeting event by dropping the file on a meeting event window displayed within a calendar window. The file is copied to a directory on the originator's computer and a meeting invitation is created containing a directory path to a corresponding directory on a server that stores a copy of the file. The meeting invitation is sent to the server for distribution to attendees of the meeting, who access the file from the server. The originator also indicates permissions on the server directory for the attendees. The file may be modified by the originator, or by an attendee having appropriate permissions, by dropping a modified version on the meeting event window. The server notifies the attendees and/or the originator that the meeting event has changed.

### RELATED APPLICATIONS

This application claims the benefit of U.S. Provisional Patent application No. 60/835,510 filed Aug. 4, 2006, which is hereby incorporated by reference.

### BACKGROUND OF THE INVENTION

The present inventions relate generally to managing an electronic calendar and more particularly to associating files with calendar events.

An electronic calendar is typically implemented on a data processing system, such as a general purpose computer system or a personal digital assistant (PDA) or a cellular telephone or a media player (e.g. an iPod) or other types of devices. These electronic calendars typically allow a user to display different time intervals or time ranges within a calendar. For example, an electronic calendar will typically allow a user to display at least a portion of a day, a full day, a portion of a week or a full week, several weeks, or a month, or a plurality of months, or even multiple years. The electronic calendars further typically include user interfaces for allowing a user to move between the different time durations or time ranges and to enter events and reminders onto the calendar. The events and/or reminders typically include some text specifying the event as well as data specifying the duration in time of the event and other information. A user can typically save these reminders or events at a particular time on the calendar and then later retrieve the information from the calendar to see what events are upcoming, to plan for events, etc.

Oftentimes, an event may require several people to attend the event, such as a meeting or a party, etc. In these circumstances, the creator of the event on the calendar will typically send out an invitation to those being invited to or requested to attend the event. Prior data processing systems allow a user to create an event on a calendar and then cause an electronic message to be sent out to those being invited or requested to attend the event. The message may be sent by an electronic message, such as email, or some other type of notification about the event. These invitations are received by attendees or others required to attend in an email form which does not display the invitation in a calendar or in the context of a calendar with other events listed on the calendar which have already been accepted. Hence, a user cannot see the date and time of the invitation in the context of other events already on the user's calendar. Moreover, prior systems and methods do not include a calendar which is devoted to showing invitations which have not yet been accepted.

In addition, the creator of the event may want to share files related to the event, such as an agenda, a presentation or the like, with the attendees. Currently, the creator must manually attach the files to the invitations or manually load the files to a storage device that is accessible by all the attendees. If the creator adds, deletes or modifies the files, the creator must manually inform each attendee of the change. Furthermore, if the attendee deletes or misfiles the invitation prior to detaching or retrieving the files, there is no easy way for the attendee to find the files.

### SUMMARY OF THE DESCRIPTION

A meeting originator associates a file with a meeting event by dropping the file on a meeting event window displayed within a calendar window. The file is copied to a directory on the originator's computer and a meeting invitation is created containing a directory path to a corresponding directory on a server that stores a copy of the file. The meeting invitation is sent to the server for distribution to attendees of the meeting, who access the file from the server. The originator also indicates permissions on the server directory for the attendees. The file may be modified by the originator, or by an attendee having appropriate permissions, by dropping a modified version on the meeting event window. The server notifies the attendees and/or the originator that the meeting event has changed.

One or more methods described herein may be performed by a data processing system, such as a general purpose computer system, a PDA, a cellular telephone, a media player, etc. These devices may use one or more computer programs to perform these methods and they may include machine or computer readable media containing those computer programs.

The methods and/or computer programs of any one of these embodiments may be compliant with standards for calendaring applications, such as iCalendar and vCalendar, and may allow for the importation of data from other applications such as Entourage, or other calendaring programs.

In addition, in at least certain embodiments, the methods or systems described herein may enable copy and paste operations with other applications, and may enable drag and drop manipulations or the use of a spell checker, or the integration with email applications and address book applications for management of personal information. Furthermore, in at least certain embodiments, the methods and systems described herein may also permit users to publish their calendars to others (e.g. publish their calendar through the use of the Internet) and may also allow a user to subscribe to other calendars, thereby coordinating or managing events of one user with those of another.

### BRIEF DESCRIPTION OF THE DRAWINGS

The present invention is illustrated by way of example and not limitation in the figures of the accompanying drawings in which like references indicate similar elements.

FIG. 1 shows an exemplary data processing system which may be used in at least certain embodiments described herein.

FIG. 2 is a flow chart which depicts an exemplary embodiment described herein.

FIGS. 3A, 3B, 3C, 3D, and 3E show examples of a user interface which includes a list of selectable calendars.

FIG. 3F shows another example of a user interface which includes a plurality of user-selectable calendars in a list, each of which may be toggled on or off and thereby shown or not shown on the user's calendar within the calendar window.

FIG. 4A shows a flow chart illustrating another exemplary method described herein.

FIG. 4B is another flow chart showing another exemplary embodiment of the methods described herein.

FIGS. 5A, 5B, 5C, 5D, 5E, and 5F illustrate exemplary user interfaces for creating an event or invitation.

FIGS. 6A, 6B, and 6C illustrate exemplary user interfaces showing how invitations may be received and displayed within a user's calendar even before the invitation is accepted.

FIGS. 7A and 7B illustrate exemplary user interfaces showing how files may be associated with a calendar event by a creator of the event.

FIG. 7C illustrates an exemplary user interface showing how a user can access files associated with a calendar event.

FIG. 8 is a flow chart which depicts an exemplary embodiment of a method that processes files pertaining to a calendar event.

FIGS. 9A-C are flow charts depicting embodiments of methods for clients and servers in processing file pertaining to a calendar event

FIGS. 10A-C illustrate an alternate user interface for associating files with a calendar event.

FIG. 11 illustrates a dialog box presented when a user changes files associated with a reoccurring calendar event.

### DETAILED DESCRIPTION

The subject invention will be described with reference to numerous details set forth below, and the accompanying drawings will illustrate the invention. The following description and drawings are illustrative of the invention and are not to be construed as limiting the invention. Numerous specific details are described to provide a thorough understanding of the present invention. However, in certain instances, well known or conventional details are not described in order to not unnecessarily obscure the present invention in detail.

The present description includes material protected by copyrights, such as illustrations of graphical user interface images. The owners of the copyrights, including the assignee of the present invention, hereby reserve their rights, including copyright, in these materials. The copyright owner has no objection to the facsimile reproduction by anyone of the patent document or the patent disclosure, as it appears in the Patent and Trademark Office file or records, but otherwise reserves all copyrights whatsoever. Copyright Apple, Inc. 2006.

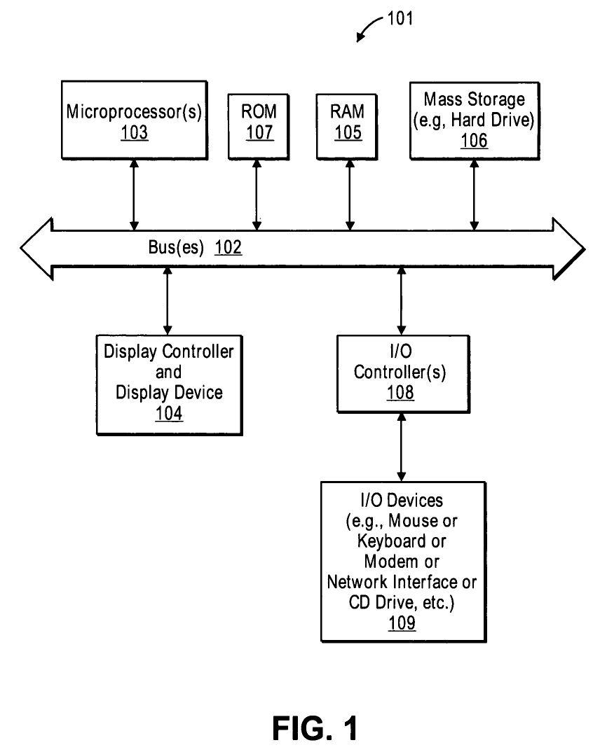

FIG. 1 shows one example of a typical computer system which may be used with the present invention. Note that while FIG. 1 illustrates various components of a computer system, it is not intended to represent any particular architecture or manner of interconnecting the components as such details are not germane to the present invention. It will also be appreciated that PDAs, cellular telephones, media players (e.g. an iPod), devices which combine aspects or functions of these devices (e.g. a media player combined with a PDA and a cellular telephone in one device), network computers, an embedded processing device within another device, and other data processing systems which have fewer components or perhaps more components may also be used to implement one or more embodiments of the present inventions. The computer system of FIG. 1 may, for example, be a Macintosh computer from Apple, Inc.

As shown in FIG. 1, the computer system 101, which is a form of a data processing system, includes a bus 102 which is coupled to a microprocessor(s) 103 and a ROM (Read Only Memory) 107 and volatile RAM 105 and a non-volatile memory 106. The microprocessor 103 may be a microprocessor or set of microprocessors from Intel or a G3 or G4 microprocessor from Motorola, Inc. or one or more G5 microprocessors from IBM. The bus 102 interconnects these various components together and also interconnects these components 103, 107, 105, and 106 to a display controller and display device 104 and to peripheral devices such as input/output (I/O) devices which may be mice, keyboards, modems, network interfaces, printers and other devices which are well known in the art. Typically, the input/output devices 109 are coupled to the system through input/output controllers 108. The volatile RAM (Random Access Memory) 105 is typically implemented as dynamic RAM (DRAM) which requires power continually in order to refresh or maintain the data in the memory. The mass storage 106 is typically a magnetic hard drive or a magnetic optical drive or an optical drive or a DVD RAM or other types of memory systems which maintain data (e.g. large amounts of data) even after power is removed from the system. Typically, the mass storage 106 will also be a random access memory although this is not required. While FIG. 1 shows that the mass storage 106 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 102 may include one or more buses connected to each other through various bridges, controllers and/or adapters as is well known in the art. In one embodiment the LO controller 108 includes a USB (Universal Serial Bus) adapter for controlling USB peripherals and an IEEE 1394 controller for IEEE 1394 compliant peripherals.

It will be apparent from this description that aspects of the present invention may be embodied, at least in part, in software. That is, the techniques may be carried out in a computer system or other data processing system in response to its processor, such as a microprocessor, executing sequences of instructions contained in a memory, such as ROM 107, RAM 105, mass storage 106 or a remote storage device. In various embodiments, hardwired circuitry may be used in combination with software instructions to implement the present invention. Thus, the techniques are not limited to any specific combination of hardware circuitry and software nor to any particular source for the instructions executed by the data processing system. In addition, throughout this description, various functions and operations are described as being performed by or caused by software code to simplify description. However, those skilled in the art will recognize what is meant by such expressions is that the functions result from execution of the code by a processor, such as the microprocessor 103.

One example of a computer program which may implement one or more methods described herein is the computer program called iCal from Apple, Inc. of Cupertino, Calif. Further information about this computer program is also provided by published U.S. Patent Application No. US2004/0044646, which published application is hereby incorporated herein by reference.

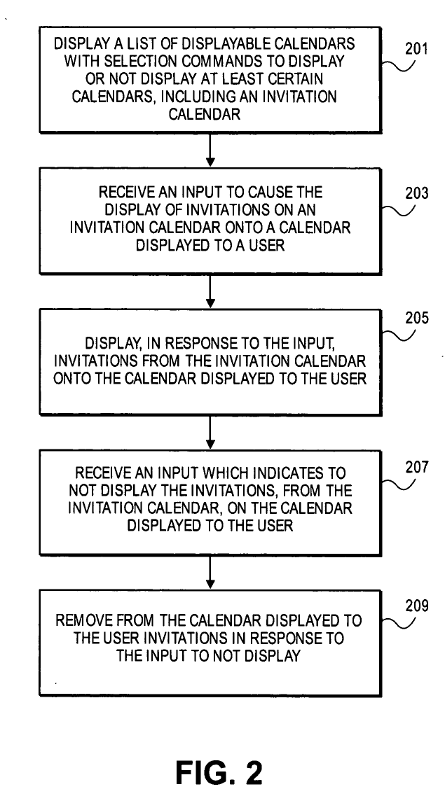

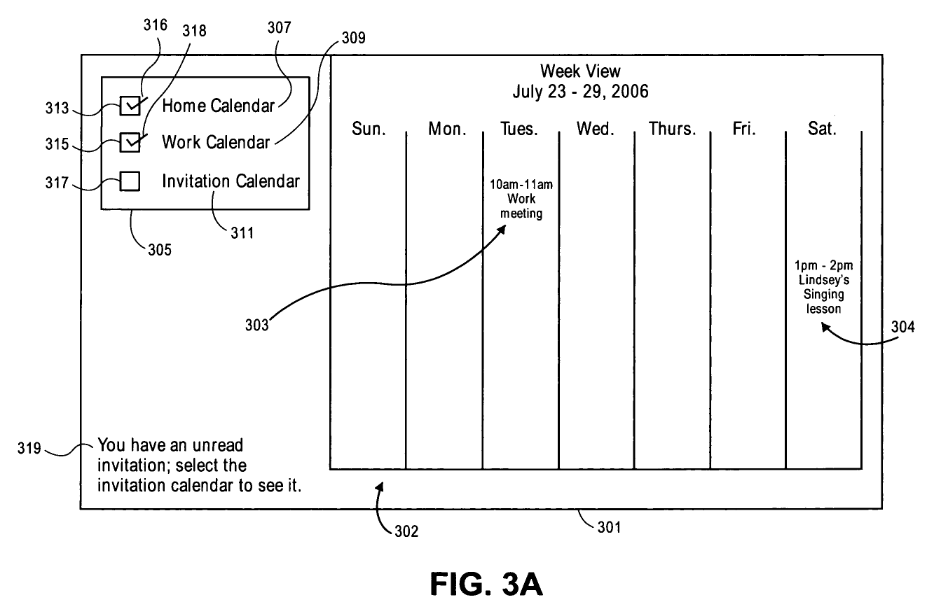

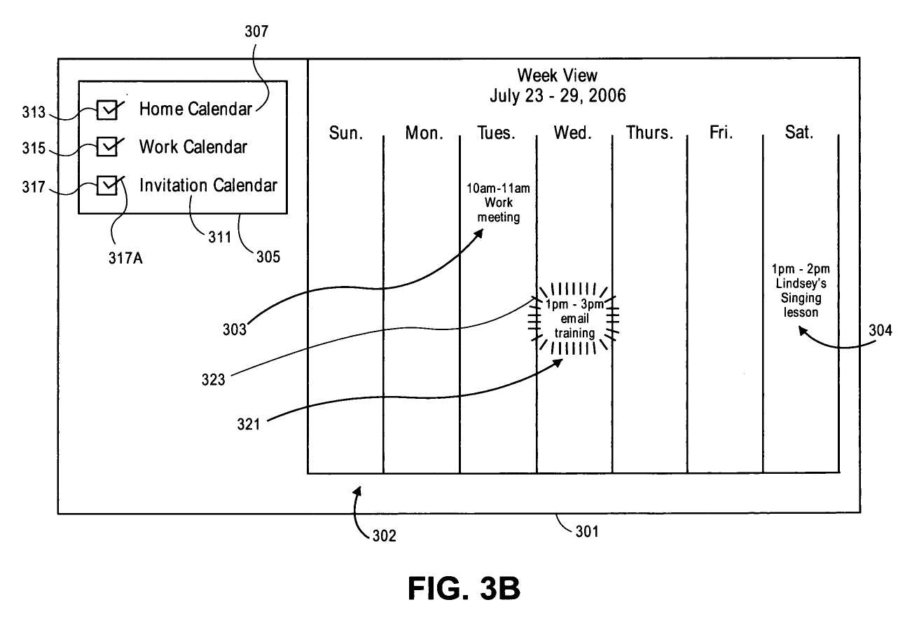

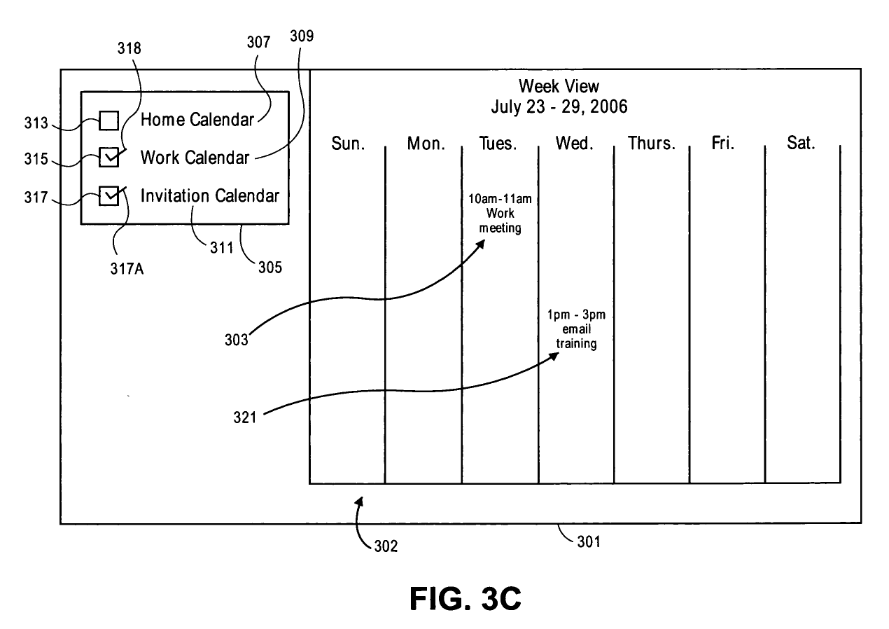

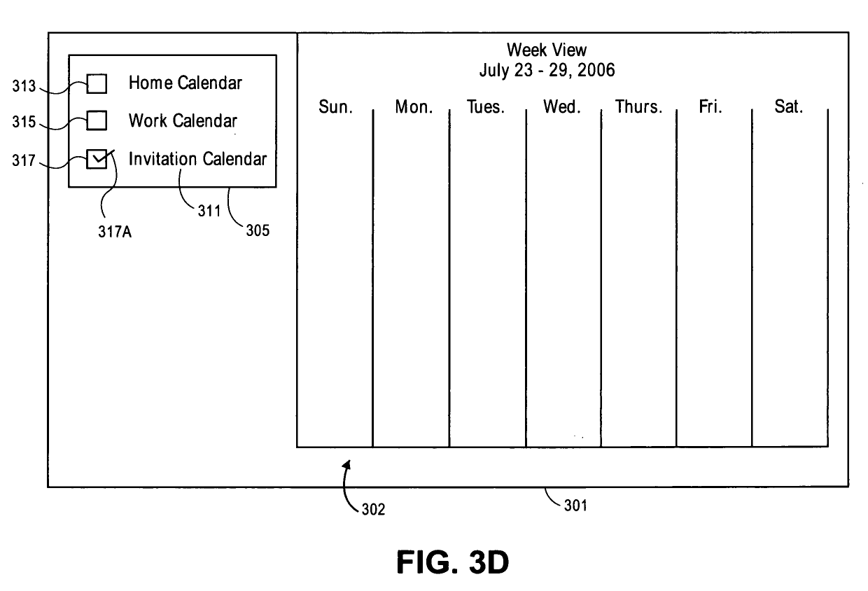

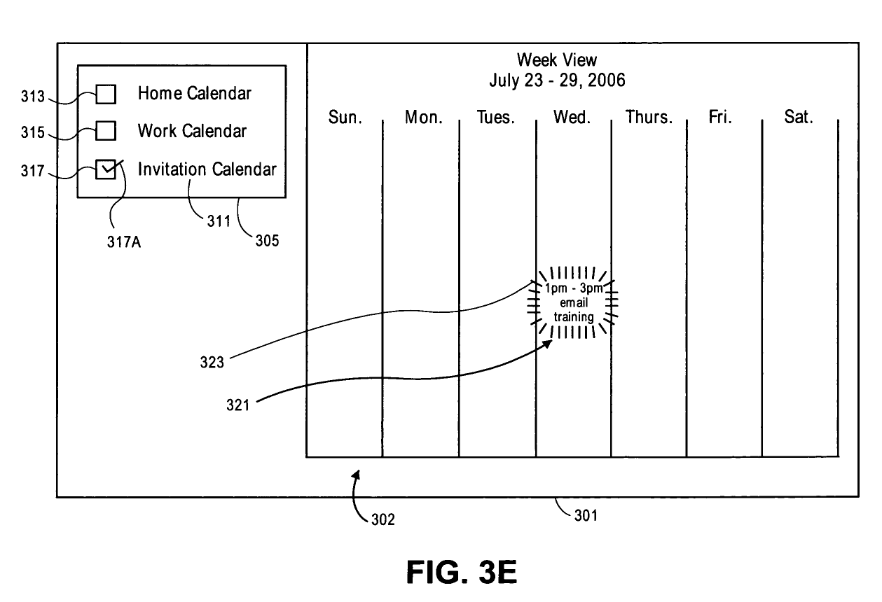

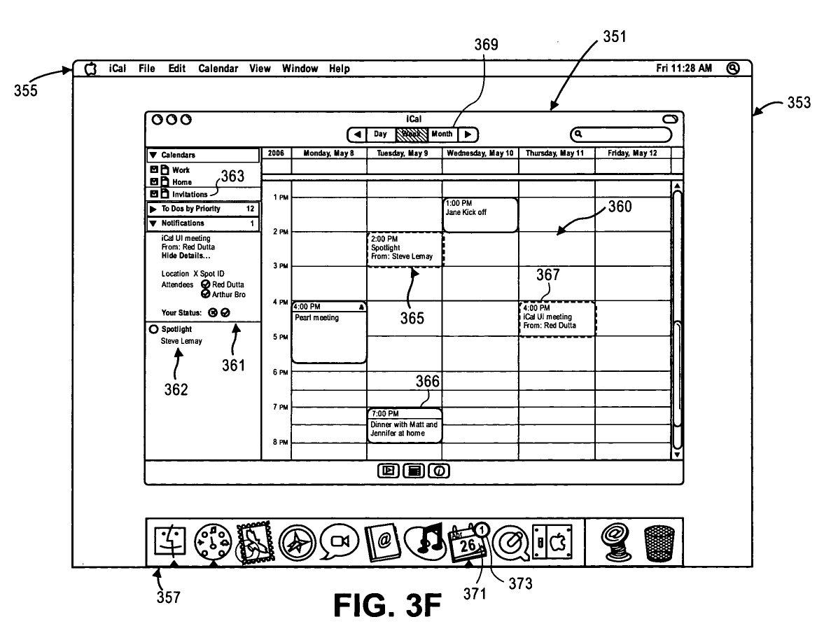

FIG. 2 shows a flow chart illustrating one or more exemplary embodiments of methods of the present inventions. The method of FIG. 2 begins in operation 201 in which a list of displayable calendars with selection commands is displayed. This list may be displayed within a calendar window and the selection commands may be displayed adjacent to each corresponding calendar which the command controls. Each command is selectable by a user to display or not display events from a particular calendar, thereby causing events to appear or not appear within the time range, such as a week view of a user's calendar. FIG. 3A shows an example of a user interface for a calendar application. The calendar application causes the display of a calendar window 301 which includes a view 302 of a user's calendar. In the example of FIG. 3A, the view is a week view, but it will be appreciated that alternative views may show a day view or a month view or other types of views. The view 302 shows an event 303 from the user's work calendar 309 shown in the list of displayable calendars 305. The view 302 also shows an event 304 from the user's home calendar 307, also shown in the list of selectable calendars 305. The list 305 also includes an invitation calendar 311. Each of the three calendars shown in the list 305 includes a respective selection command. In particular, the home calendar 307 includes a selection command 313, and the work calendar 309 includes a selection command 315, and the invitation calendar 311 includes a selection command 317. Each of these selection commands may be independently selected or not selected by the user, thereby causing events from the corresponding calendar to appear or not appear within the view 302 of the user's calendar. In the example shown in FIG. 3A, the user (or alternatively, software under default or other setting), has selected for display events from both the home calendar 307 and events from the work calendar 309 and thus check marks 316 and 318 appear within the corresponding selection commands 313 and 315. The selection commands may be activated in a variety of ways, including cursor inputs or keyboard inputs or speech inputs to the data processing system. For examples a user may position a cursor, as controlled by a mouse or other cursor control device, over the corresponding selection command and thereafter pressing a button, such as a mouse's button, to select the command or deselect the command. Also as shown in FIG. 3A, the invitation calendar has not been selected and thus there is no check mark in the selection command 317; hence, invitations from the invitation calendar which have not been accepted will not be displayed in the view 302. A notification 319 is also displayed within the window 301. This notification indicates that there is an unread invitation and tells the user to select the invitation calendar to see the unread invitation.

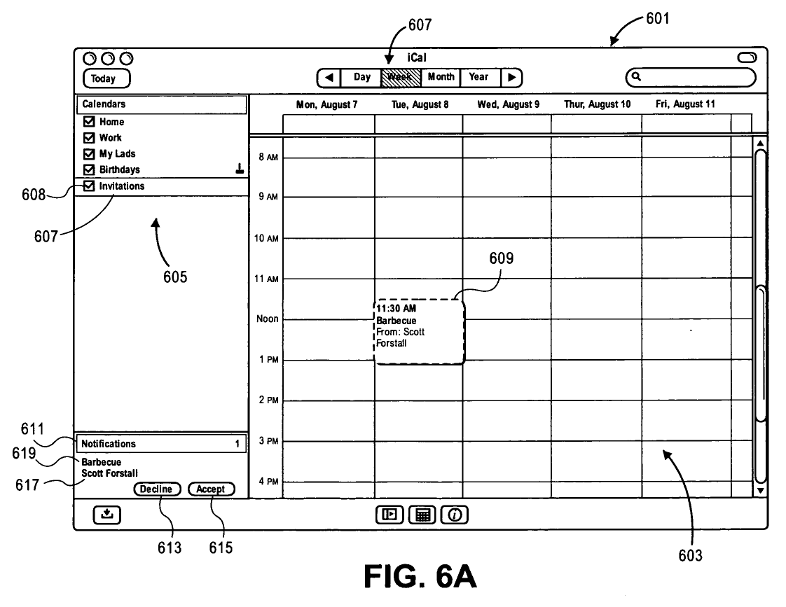

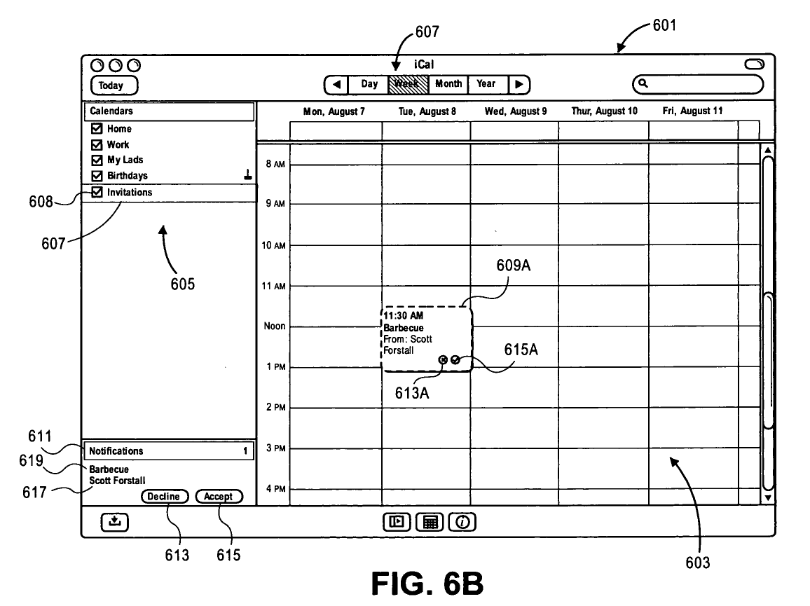

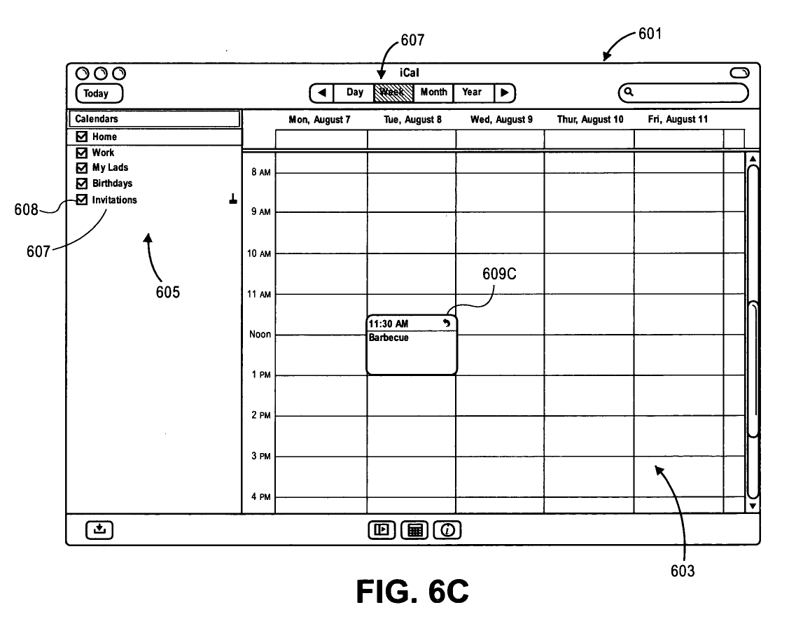

In response to the notification, the user may select the selection command 317 to cause invitations from the invitation calendar 311 to appear in the view 302. Alternatively, in response to an invitation, the system may automatically cause the selection of the selection command 317 to thereby cause unaccepted invitations to appear in the view 302 in the user's calendar. Referring back to FIG. 2, operation 203 involves receiving an input to cause the display of invitations from an invitation calendar onto a calendar displayed to a user. In response, in operation 205, invitations from the invitation calendar are displayed on a view of the user's calendar on a display device. FIG. 3B shows an example of such a view in which an unaccepted invitation from the invitation calendar is displayed in the view 302. A check mark 317A shows that the user has, or the system has, caused an input, which was received in operation 203, to thereby cause invitations to appear in the view 302. As shown in FIG. 3B, the home calendar and the work calendar have also been selected in the list 305 and hence events from both of those calendars are also displayed in the view 302 as shown in FIG. 3B. In particular, event 303 from the work calendar, event 304 from the home calendar, and the invitation 321 from the invitation calendar 311 are all concurrently displayed in the view 302. Events 303 and 304 are displayed in a fashion showing that they have been accepted, while the invitation 321 is displayed in a manner to show that it has not yet been accepted or declined. This is shown by the visual indicator 323. There are numerous alternative ways to show that the invitation 321 has not yet been accepted or declined in the view 302. For example, the unaccepted invitation may flash or be displayed with a coupon-like perimeter or displayed with text indicating it is not yet accepted, or displayed with “accept” and “reject” icons adjacent to the invitation on the view 302, etc. In an alternate embodiment, a “tentative” icon may be displayed as well. FIG. 3F shows a particular embodiment in which the invitations 365 and 367, which have not yet been accepted, are displayed in a view of a calendar while other events which have been accepted, such as event 366, is displayed differently. FIG. 6B shows an example in which an invitation which has not yet been accepted, such as invitation 609A, includes “accept” and “decline” icons which may also be used to differentiate an unaccepted invitation from other events which have been accepted. In an alternate embodiment, a “tentative” icon may also be shown. A user may decide, while viewing the user interface shown in FIG. 3B, to view only invitations from the invitation calendar, and this result is shown in FIG. 3E in which only the invitation calendar has been selected through the selection command 317, while the other selection commands 313 and 315 have been deselected, such that events from the home calendar and the work calendar do not appear in the view 302 shown in FIG. 3E. Hence, the list of selectable calendars 305 allows a user to toggle calendars on or off independently to focus on a particular calendar, although it will be appreciated that the user interface shown in FIG. 3B gives the user the ability to see the invitation which has not yet been accepted relative to other events in additional calendars beyond the invitation calendar. It will be understood that there may be a plurality of invitations which have not yet been accepted which are shown on the invitation calendar, and an example of this is shown in FIG. 3F which includes two unaccepted invitations 365 and 367 along with other events from selected calendars as shown in FIG. 3F. It will be appreciated that a user may remove the invitations from view 302 shown in FIG. 3B by deselecting the invitation calendar 311 in the list 305, and this will return the view to the state it was in FIG. 3A. This is also shown as operations 207 and 209 of FIG. 2.

The user may accept or decline an invitation by using one of a variety of different user interfaces as further described herein. FIGS. 3C and 3D show an example of the user interface of one embodiment after an invitation has been accepted. It can be seen from FIG. 3C that the view 302 now includes the event 321 which is an accepted invitation, and it is displayed as other events are also displayed which have been accepted. Thus, the appearance of the event 321 is similar to the appearance of the event 303. Also note that events from only the work calendar are now shown in the view 302, while events from the home calendar are not shown (and hence the event 304 is not shown in the view 302 of FIG. 3C). FIG. 3D shows the invitation calendar 311 only in the view 302. There are no invitations shown in the view 302 of FIG. 31) because the invitation related to event 321 has been accepted and hence it has been removed from the invitation calendar as shown in the view 302 of FIG. 3D.

FIG. 3F shows one example of a user interface according to one embodiment of the present inventions. This user interface includes a calendar window 351 shown on a desktop 353. A dock 357 is also shown on the desktop 353. The dock includes an icon 371 representing the calendar application which is running and causing the display of the calendar window 351. The dock also includes a notification icon 373 which indicates that the system has received one notification relating to an invitation. The user interface also includes a pull-down menu region 355. The calendar program window 351 includes a user interface 369 for selecting a time range, such as a week or day or month range for display of events within the view 360 of the user's calendar. As shown in FIG. 3F, the week range has been selected from the user interface 369, causing a week view to appear in the view 360. Numerous events from three different calendars (a work calendar, a home calendar, and an invitations calendar) are shown within the view 360. For example, event 366 from the home calendar is shown with several events from the work calendar. In addition, two invitations 365 and 367 are also shown in the view 360 concurrently with the other events from the other calendars. As with the example shown in FIG. 3A, the calendars may be selectively turned on or off thereby displaying or not displaying events from a selected calendar. As can be seen from FIG. 3F, the invitations calendar 363 has been selected for display, causing the invitations 365 and 367 to appear without a particular color which is related to the other calendars and to appear with a coupon-like perimeter, indicating to the user that these events are invitations which have not yet been accepted. A notifications portion of the calendar program window 351 shows two notifications 361 and 362. The notification 361 has been expanded to show details about this particular notification which relates to the invitation 367 shown in a particular time on Thursday, May 11. Note that the invitations are shown at the particular time of the invitation on the view 360 and that the duration of the invitation is also shown by the area that the invitation spans on the view 360. This is similar to how the area of the events which have been accepted, such as event 366, also indicates the duration of the event. The notification 361 includes an “accept” icon and a “decline” icon for accepting or declining the invitation 367. In an alternative embodiment, these icons may be shown only when the invitation 367 is within the view 360 or in addition to the invitation 367 on the view 360.

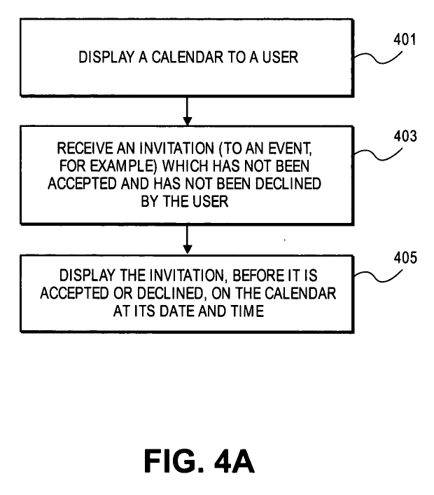

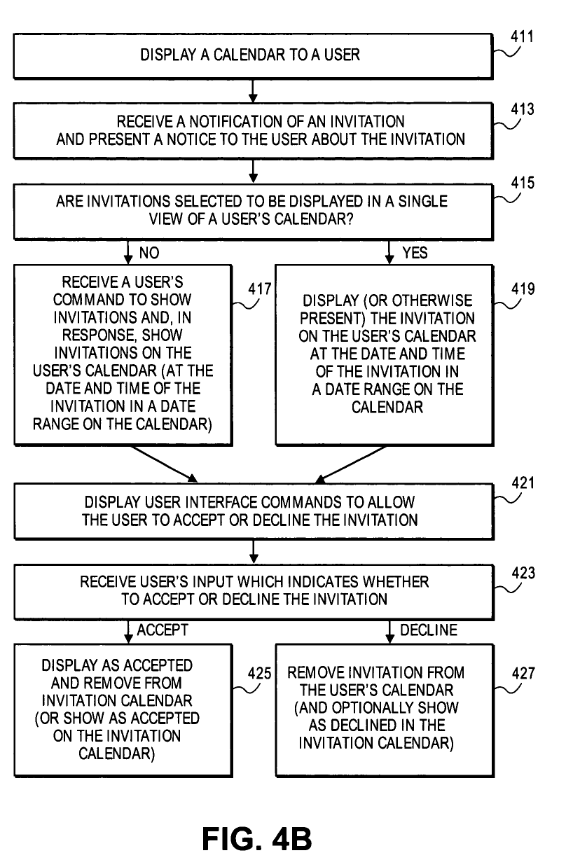

FIG. 4A is a flow chart indicating an exemplary method according to one aspect of the present inventions. In operation 401, a calendar is displayed to a user. Then in operation 403, an invitation to an event which has not yet been accepted and which has not yet been declined, is received. This invitation is displayed, in operation 405, before it is accepted or declined. It is displayed, in operation 405, on the calendar at its date and time and may include an indication of the duration of the event related to the invitation. Examples of user interfaces related to this method of FIG. 4A have been provided above, including, for example, the user interface in FIG. 3B and the user interface shown in FIG. 3F in which invitations are displayed before they are accepted or declined on the user's calendar at the date and time of the invitation.

FIG. 4B shows a more detailed method than the method of FIG. 4A, and this more detailed method is yet another exemplary embodiment according to at least one aspect of the present inventions. Examples of user interfaces which illustrate at least portions of this method have been provided herein, including, for example, FIGS. 3A, 3B, 3F, and other figures. In operation 411, the data processing system displays a calendar to a user. In operation 413, a notification of an invitation is received, and the data processing system presents a notice to the user about the invitation. It will be appreciated that in certain embodiments, the sequence of operations 413 and 411 may be reversed. For example, the calendar may be displayed in operation 411 after receiving the notification 413, and this may occur automatically in response to the notification. It will be also appreciated that various other sequences for other operations in the methods shown in FIG. 4B may be utilized by at least certain embodiments of the present inventions. In operation 415, it is determined whether or not invitations have been selected to be displayed in a view of a user's calendar. In one embodiment, this may involve determining whether or not a selection command, such as selection command 317, has been selected, either by the user or by the system. If it has not been selected, then operation 417 follows, and if it has been selected, then operation 419 follows as shown in FIG. 4B. In operation 417, the data processing system receives a user's command (or a system input or a programmatic input) to show the invitations, and in response, the invitations are shown on the user's calendar at the date and time of the invitation in a selected date range on the calendar. If the invitations had been selected, as determined in operation 415, then operation 419 follows in which the invitation is displayed or otherwise presented on the user's calendar. In operation 421, user interface commands are displayed to allow the user to accept or decline the invitation. The user's input (or input from the system or a software program) is received in operation 423, which input indicates whether or not to accept or decline the invitation. If the invitation is accepted, then operation 425 follows, and if the invitation is declined, then operation 427 follows. In operation 425, the invitation is displayed as accepted and thus the event appears as other accepted events appear on the user's calendar. Optionally, the event which constitutes the invitation is also removed from the invitation calendar or is shown as accepted on the invitation calendar. In operation 427, if the operation is declined, then it is removed from the user's calendar and optionally shown as declined on the invitation calendar. In another embodiment, the declined event may also be removed from the invitation calendar in addition to removing it from the user's calendar.

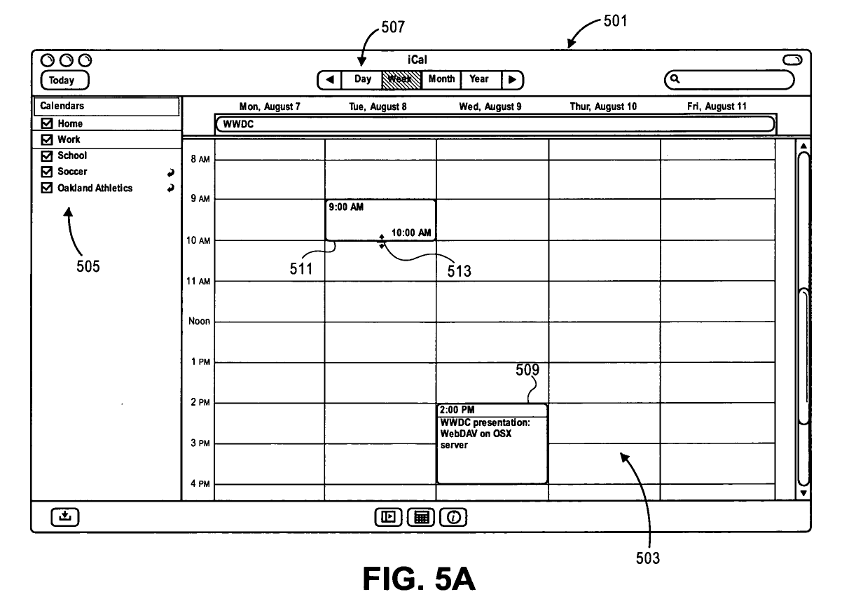

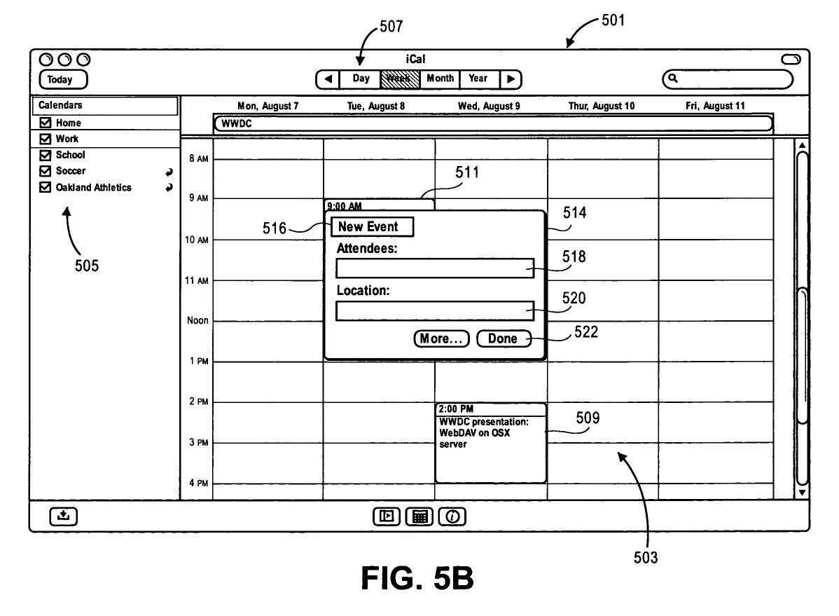

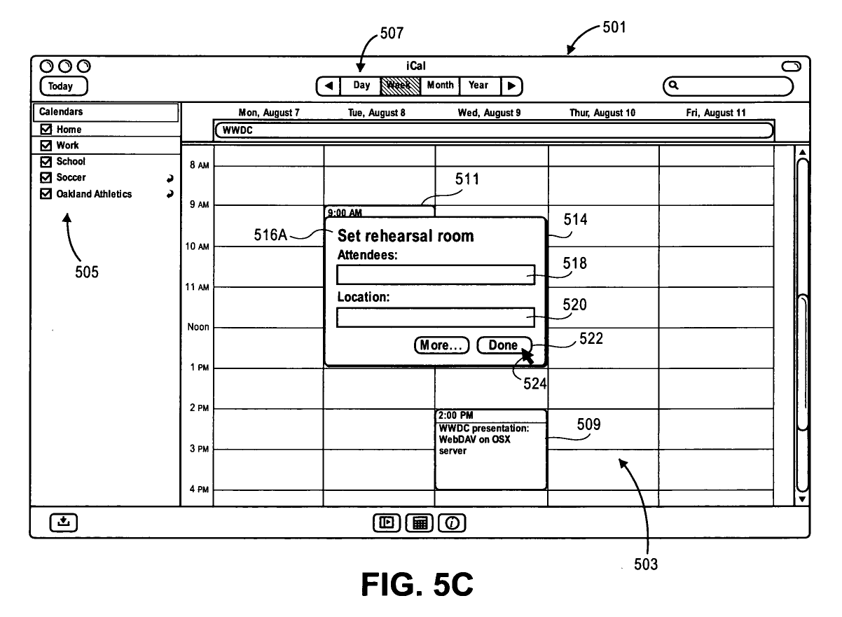

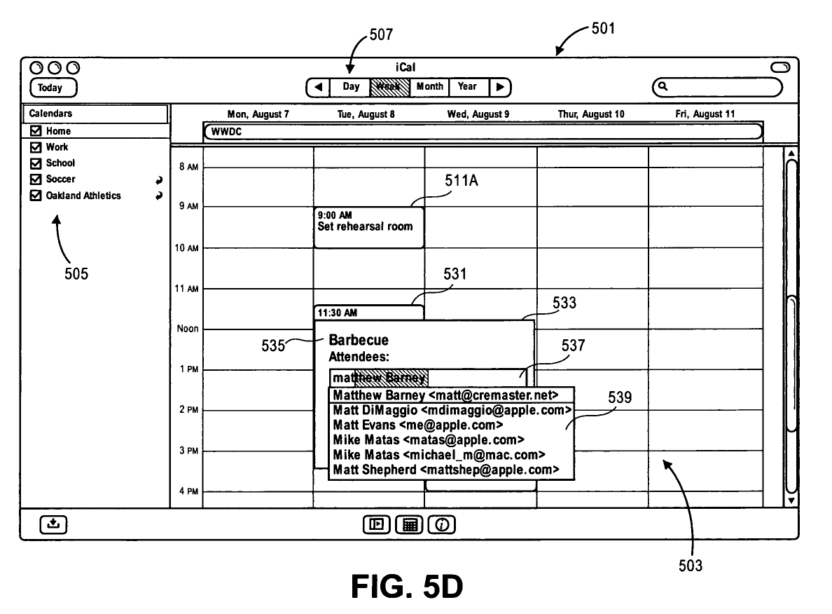

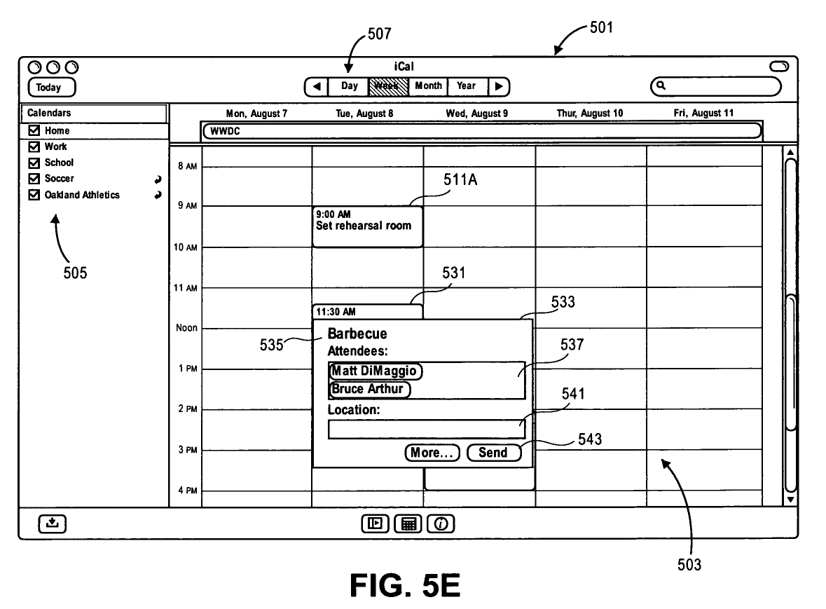

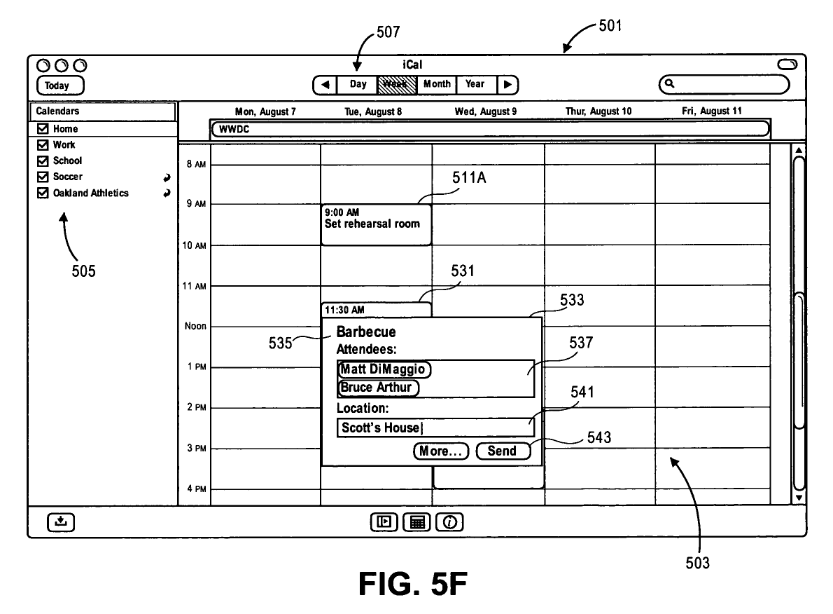

Additional examples of embodiments of user interfaces will now be provided by FIGS. 5A-5F and FIGS. 6A-6C. FIGS. 5A-5F show examples of how events are created within a calendar and how invitations may be created from the sender's side of an invitation. FIG. 5A shows an example of a calendar application window 501 which includes a view 503 of a user's calendar. This view may be selected to be at one of a plurality of different time ranges, such as a day range or a week range or a month range or a year range, as determined by the range selector 507. In the particular example shown in FIG. 5A, an input has been received which instructed the system to display events within a week range in the view 503. The calendar application window 501 also includes a list 505 of selectable calendars, which in this case have all been selected for having their events displayed within the view 503. The view 503 includes an event 509, which has already been scheduled, and an event 511, which is currently being scheduled as shown in the example of FIG. 5A. The cursor 513 is being used to select the duration of the event 511 as shown in FIG. 5A. After the duration has been selected, a dialog window 514 is displayed (as shown in FIG. 5B), allowing user input into three fields 516, 518, and 520. The field 516 allows the user or the system to enter text which represents the name of the event or other information. The field 518 allows the user or the system to enter attendees; in certain embodiments, the user or the system may merely enter the first part of an attendee's name and the system will search through contact databases or address databases for that person's name and may include contact information, such as an email address or a phone number or other contact information which can be used to alert the attendees of the events/invitation as shown below. In the case of the example shown in FIGS. 5B and 5C, there will be no attendees, and thus the field 518 remains blank in both FIGS. 5C and 5B. Similarly, the location field 520 also remains blank. After the user has entered text into field 516 as shown in FIG. 5C, the user can then complete the entry of data for the event 511 by selecting the “done” button 522 by positioning a cursor 524 over the done button; in other embodiments, other inputs may be used to indicate that the user has completed entry of information with respect to an event. For example the user may press a key, or button, such as a return button on a keyboard.

FIGS. 5D, 5E, and 5F show an example of user interfaces for creating an event and an invitation at the sender's side of the invitation. The sequence of user interfaces shown in FIGS. 5D, 5E, and 5F follow the sequence of user interfaces shown in FIGS. 5A, 5B, and 5C. Hence, the event 511 has turned into event 511A, as shown in FIG. 5D, because the user has completed entry of information in connection with that event which now appears in the view 503. The user, as shown in FIG. 5D, has begun creating a new event 531 which will also become an invitation because the event has two attendees. As shown in FIG. 5D, the user has entered a name for the event/invitation in a field 535 within the window 533 which accepts input for the event/invitation. The user has also entered a portion of one of the attendees' names within the field 537 which specifies the attendees. In response, the system returns a list of names which match the text entered into field 537. In particular, the system returns a list 539 from which the user can select one or more names for entry into the field 537. In the particular example shown in FIG. 5D, the attendees are specified by name and by email address and notifications about the invitation will be sent to the attendees by email. In alternative embodiments, other messaging techniques, such as telephone contacts, instant messaging addresses or contacts, etc. may be alternatively used or used in addition to email addresses. After a selection of the attendees as shown in FIG. 5D, the window 533 is ready to receive a location input into field 541 as shown in FIG. 5E. The user or the system then enters a location in the field 541 as shown in FIG. 5F and at this point the invitation is ready to be sent, and the event's data entry will be completed after the user selects the “send” button 543 as shown in FIG. 5F. Selecting that button will then cause the event to be displayed as event 531 on the sender's calendar and will also cause a notification, in this case by email, to be sent to the two attendees listed in field 537. In the embodiment discussed relative to FIGS. 6A-6C on the attendee's side, these emails are used to provide a notification from an email program to the calendaring program at the attendee's side so that the notification can be received directly within the calendaring window rather than merely in an email application window.

FIGS. 6A, 6B, and 6C illustrate the receipt of the invitation at the attendee's side of an invitation. In this particular example, the invitation created and sent from FIGS. 5D, 5E, and 5F is received at the attendee's side as shown in FIGS. 6A, 6B, 6C. The attendee is using a data processing system which displays a calendar application window 601 which includes a view 603 showing a week time range in the view 603 as determined by the interface control 607 in which the week time range is selected. The calendar application window 601 also includes a list of selectable calendars which includes an invitation calendar 607 shown in the list 605. As can be seen from FIG. 6A, all of the calendars have been selected to show their events within the view 603. For example, the invitations calendar 607 has been selected to show its events, which in this case are unaccepted invitations as shown by the selection command 608, which includes a check mark in the selection command 608. The calendar application window 601 also shows the invitation 609 and a notification 611 within the window. The invitation 609 is shown in the view 603 in a form to indicate that it has not yet been accepted or declined. In the example shown in FIGS. 6A and 6B, this form includes a coupon-like perimeter which includes a dotted or dashed line. Further, the invitation is shown without any of the colors used to indicate other events for other calendars. For example, all events from the home calendar may be shown in red while events from the work calendar may be shown in green, etc. As noted above, other types of indicators may alternatively be used or used in addition to those mentioned to show that the event is an invitation which has not yet been accepted. The notification 611 results from the email sent from the sender's system as a result of selecting the send button 543 shown in FIG. 5F. Alternatively, the notification could arrive from an instant messaging message or other electronic messages or even an automated phone system caused to make a phone call by selecting the send button 543 which, in turn, is received automatically by a recipient's data processing system which in turn converts this into a notification, such as notification 611. Information within the notification 611 includes the name of the event 619 and the sender of the event or invitation 617. In addition, the invitation includes an “accept” icon 615 which may be used to accept the invitation, and a “decline” icon 613 which may be used to decline the invitation. FIG. 6B shows an alternative embodiment in which accept and decline icons also appear within the invitation itself on the calendar, such as within the view 603 as shown in FIG. 6B. In particular, a decline icon 613A and an accept icon 615A are shown within the invitation 609A as shown in the view 603. The user can accept the invitation by selecting either icon 615 or 615A shown in FIG. 6B, and can decline the invitation by selecting either icon 613 or 613A. Accepting the invitation causes the invitation to be removed, in at least certain embodiments, from the invitation calendar 607, and causes the event to be displayed as a normal event rather than an invitation as shown in FIG. 6C, in which the event 609C now becomes an event within the home calendar and assumes the color of events (e.g. red) of events within the home calendar.

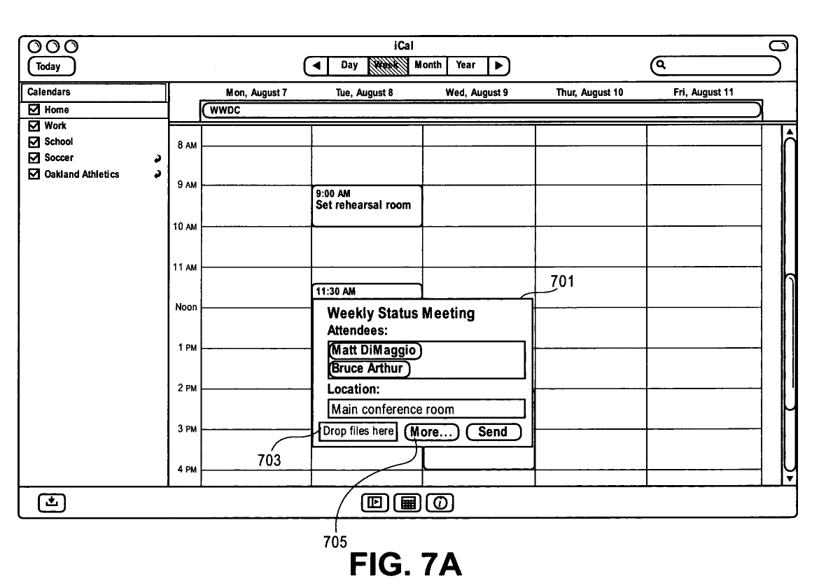

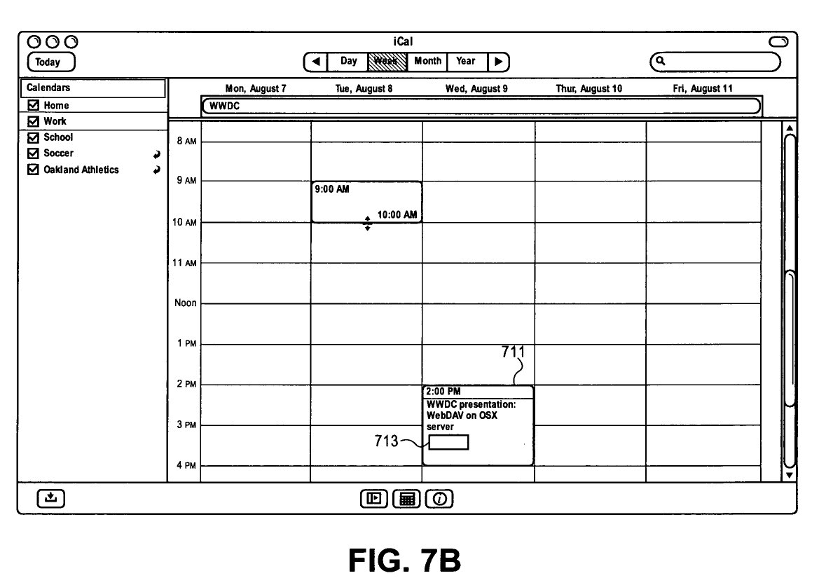

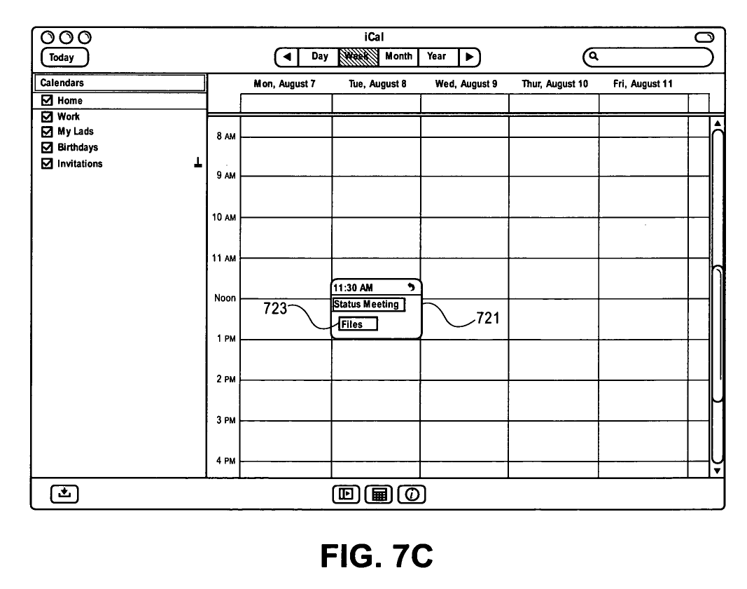

In another embodiment shown in FIG. 7A, a new event window 701 on the creator's side includes a “drop box” 703. The user can drag and drop files on the drop box 703 to associate the files with the event being created. Alternatively, other interfaces techniques can be used to indicate that files are to be added to the drop box 703. It will be appreciated that the drop box 703 may appear on the initial new event window 701 or a subsequent window displayed in response to the user selecting a “more” button 705. The drop box 703 is marked in some fashion that indicates to the user that it is a “hot” zone to receive files. In one embodiment, the drop box 703 is represented in the window 701 with icon, such as a folder or a disk. Optionally, the calendar application may prompt the creator to set access permissions on the dropped file to limit the type of operations an attendee can perform on the file. The prompting may appear in a separate window, such as a dialog box, or in the new event window 701.

Once the calendar event is created and the invitations sent, the creator may need to add, delete or modify the files for the event. As illustrated in FIG. 7B, a previously created event 711 shown on the creator's calendar also contains a drop box 713. If the user drops a modified file on the drop box 713, the calendar application replaces the old version of the file with the modified version. If the user wishes to delete a file, in one embodiment, selecting the drop box 713 will display a list of files currently associated with the event so the user can indicate which file should be deleted. It will be appreciated that the currently associated files may be shown one at a time, in groups, or through the use of a scrolling list as is standard in user interfaces.

Some or all of files associated with the event may be stored on a server, such as a calendar server, or may reside on any computer networked to the server. A logical pointer or URL to the files, or to a folder containing the files, may be used by the attendee to obtain the files as described next.

Turning now to FIG. 7C, on the attendee's side the corresponding calendar event window 721 contains a file indicator 723. In one embodiment, the file indicator 723 is linked to a folder address and opens the folder containing the files when the user selects the file indicator 723. The files may be automatically downloaded to the user's computer when the folder is opened. In an alternate embodiment, the file indicator 723 is a drop down box containing a list of folders or individual files that allows the user to manually select the files to be downloaded or printed. The file indicator 723 is marked to indicate that it is a selectable area of window 721. In one embodiment, the file indicator 723 is represented as an icon, such as a folder or disk.

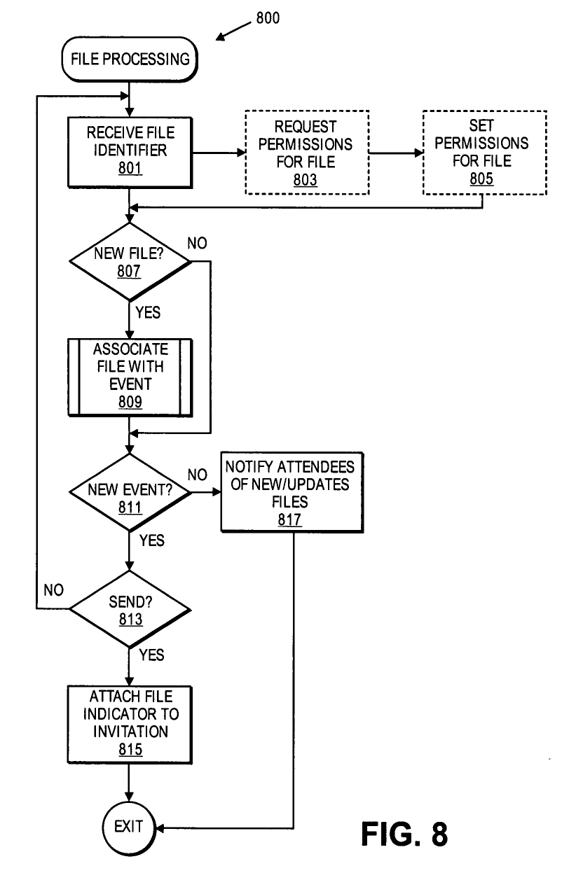

FIG. 8 is a flow chart that represents one embodiment of a file processing method 800 performed by a calendar application for each file dropped on an event window hot zone, such as drop box 703 in FIG. 7A. The method 800 receives an unique identifier for the file at block 801. As shown in phantom, optionally the method 800 requests and set appropriate permissions for the files (blocks 803, 805). If this is a new file for the event (block 807), at block 809 the method 800 associates the file with the event in one of several ways as described further below. If this is not a new file, i.e., a modified version of an existing file, the association between the file and the event is already established and control passes to block 811. If this is a new event (block 809), when the user selects the send button (block 813), the method 800 attaches a file indicator to the invitation at block 815 to create the calendar event window 721 illustrated in FIG. 7C. As previously described, the file indicator may be a link to a folder containing the files or a list of folders or individual files. If the current event is one that was previously created, the method 800 notifies the attendees that a new or modified file is available (block 817). The method 800 may send an email to each attendee or cause a message to be shown in each attendee's calendar.

In one embodiment, the processing represented by block 809 creates metadata that associates the file and the event. The association metadata may be part of standard metadata for the file, standard metadata for the event, or may be maintained separately from both the file and the event. In one embodiment, an indexing application, such as Spotlight from Apple, Inc., extracts the association metadata from the file or the event and adds the association metadata to a metadata store maintained by the indexing application. Subsequently, the indexing application can quickly search for files related to a particular event and display those files in a search window separate from the calendar application. The search window may also display an indication of which event the files are associated with (e.g. the drop box for a particular event contained the files). In addition or alternatively, the indexing application may display events and indicate which files have been associated with each event (e.g., the files that were placed in the drop box for that event).

In an alternate embodiment, the processing represented by block 809 creates links or pointers to the associated files within the event. In yet another embodiment, the processing represented by block 809 stores a unique identifier for each associated file in the event. Still other alternate ways of associating files with an event will be readily apparent to one of skill and are contemplated as being within the scope of the invention. Furthermore, it will be appreciated by one of skill in the art that the event window displayed within a calendar window as described herein allows files to be associated with the event without having to create an new separate window to receive the file.

Method 800 can be implemented using existing calendaring protocols and specifications, such as set forth in the iCalendar standard (IETF RFC 2445), the iTIP specification (IETF RFC 2447), and the CalDAV protocol proposal for WebDAV (IETF RFC4791 and scheduling draft proposal).

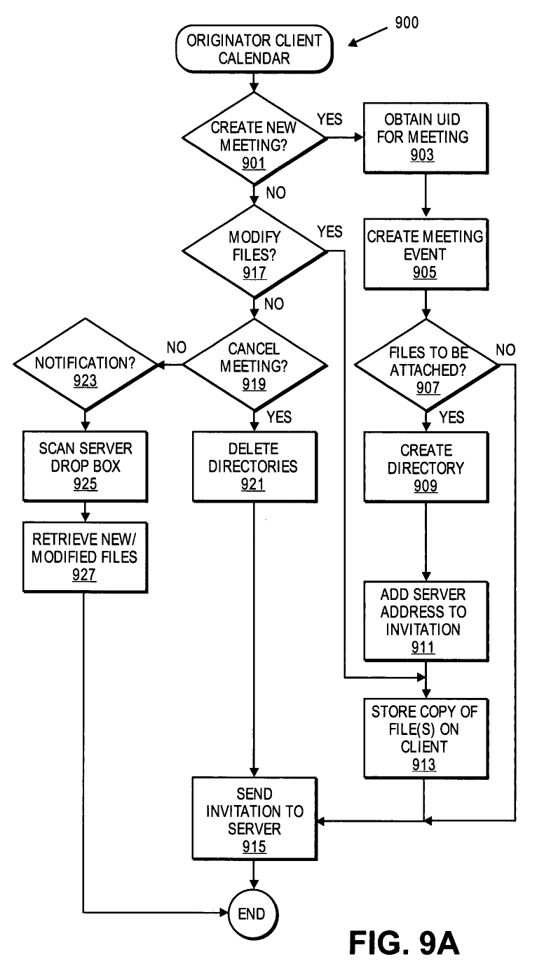

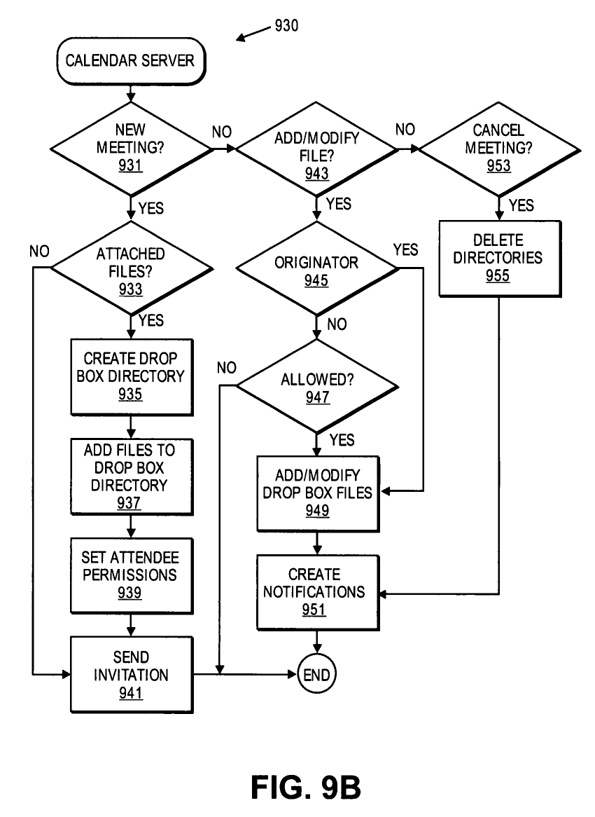

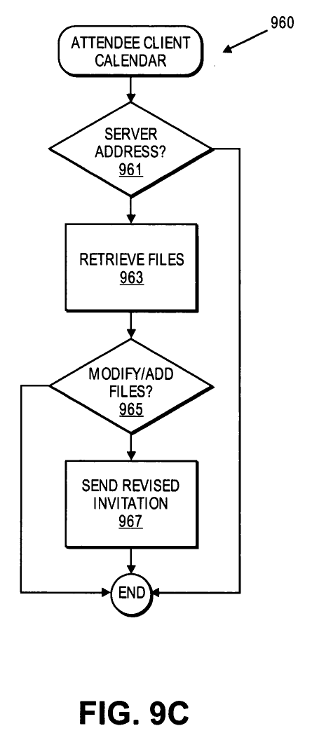

A particular embodiment in which the calendar application is implemented according to the iCalendar and CalDAV protocols as illustrated in FIGS. 9A-C. In this embodiment, the delivery of the meeting invitation is handled by a calendar server. The iCalendar meeting invitation format is extended to include an address for the drop box directory on the server. In one embodiment, the files are stored in a directory associated with the meeting originator, e.g. <server address>/calendars/users/<originator ID>dropbox/<meeting UID>.dropbox, where the originator ID and meeting UID are unique identifiers. The server address may be a web address or other network address.

Starting with FIG. 9A, when the event creator (originator) creates a new meeting event (block 901), a client calendar method 900 obtains a UID for the meeting (block 903) and creates an iCalendar meeting entry on the originator's computer, e.g. ˜/library/calendars/meetings/<meeting UID>.ics (block 905). If a document (“mockup”) is dragged and dropped to the meeting event (block 907), the client calendar method 900 creates a directory for the meeting (block 909) and adds the server address for the corresponding drop box directory to the meeting invitation (block 911). At block 913 copy of the document is stored under the meeting directory, e.g. ˜library/calendars/meetings/attachments/<meeting UID>/mockup (block 909). When the originator sends the meeting invitation to the calendar server (block 915), a calendar server method 930 shown in FIG. 9B is executed when the meeting invitation is received. If the meeting invitation is for a new meeting (block 931) and there are attached files (block 933), the method 930 creates the appropriate drop box directory (block 935) and stores a copy of the file within it, e.g. <server address>/calendars/users/<originator ID>dropbox/<meeting UID>.dropbox/mockup (block 937). The calendar server method 930 also determines the attendee permissions and sets them on the drop box directory at block 939. The method 930 sends the meeting invitation to the listed attendees using its normal procedures (block 941). In alternate embodiments, the files may be sent to the server at the same time or after the invitations are sent to the attendees.

When the attendee opens the meeting invitation, a client calendar method 960 (FIG. 9C) on the attendee's computer determines if there is a server address in the invitation (block 961) and retrieve the files from the server address if so (block 963). The attendee may also drag and drop files to the drop box on the meeting event that represent new files or modified versions of the existing files (block 965). The method 960 sends the revised meeting invitation to the server (block 967). At block 941 of FIG. 9C, when the calendar server method 930 receives a revised meeting invitation from an attendee (block 945), the method 930 determines if the attendee is allowed to make changes to the drop box (block 937). If so, the method 930 stores the file in the drop box directory (block 949) and creates an entry in the notification directories for the originator and the attendees (block 951), e.g. <server address>/calendars/users/<originator ID>/notifications/<meeting UID> and <server address>/calendars/users/<attendee ID>/notifications/<meeting UID>. In one embodiment, if the attendee modifies an existing file in the drop box, the modified file automatically overwrites the existing file. In an alternate embodiment, the method 930 prompts the user whether to overwrite or to change the name.

Turning back now to FIG. 9A, the client calendar method 900 on the originator's computer will retrieve the notification from the server (block 923) and scan the drop box directory on the server (block 925). New or modified files are retrieved from the drop box at block 927. In one embodiment, a metadata tag is associated with each file and a modified file has a different tag than the original version of the file.

If the originator drags and drops an additional or a modified file to the meeting event after the invitation was originally sent (block 917), a copy of the file is stored on the client at block 913) and a revised meeting invitation is sent to the server at block 915. Upon receipt of the revised meeting invitation from the originator, the calendar server method 930 stores the file at block 949 and creates the appropriate notification entries at block 951.

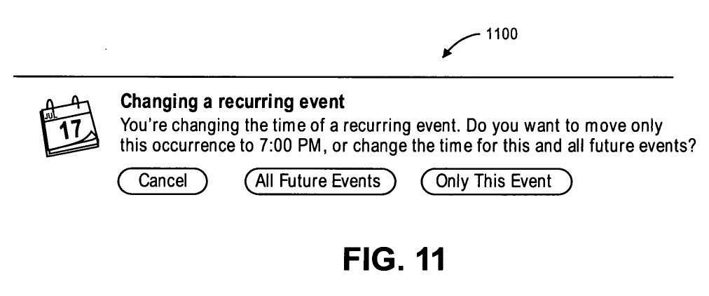

If the originator cancels a meeting (block 919), the client calendar method 900 deletes the meeting directories from the originator's computer (block 931) and ends a revised meeting invitation to the server (block 915). When the calendar sever method 930 receives the revised meeting invitation (block 953), it deletes the directories associated with the meeting from the server (block 955) and notifies the attendees of the cancellation (block 951). It will be appreciated that if the cancelled meeting is one of a reoccurring series as described in conjunction with FIG. 11 below, the method 930 will not delete directories on the server that represent the drop box for the remaining occurrences.

It will be appreciated that the methods illustrated in FIGS. 9A-C represent processing added to standard iCalendar and CalDAV protocols to handle attached files for meetings and the flow charts are not intended to illustrate all processing performed in issuing and modifying meeting invitations. It will further be appreciated that the client calendar methods 900 and 940 are typically separate execution paths within an iCalendar client calendar application.

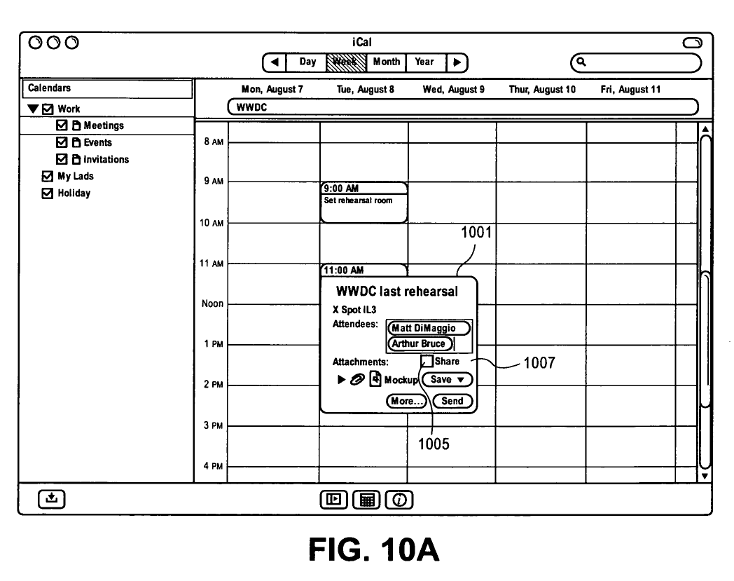

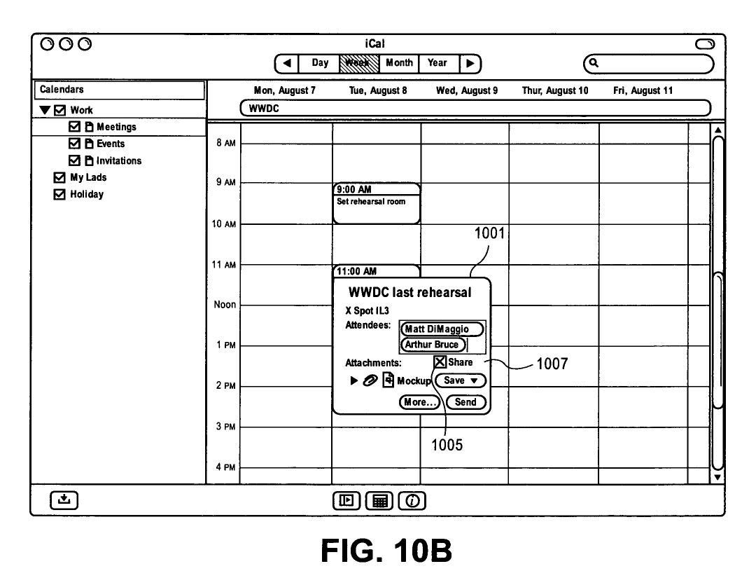

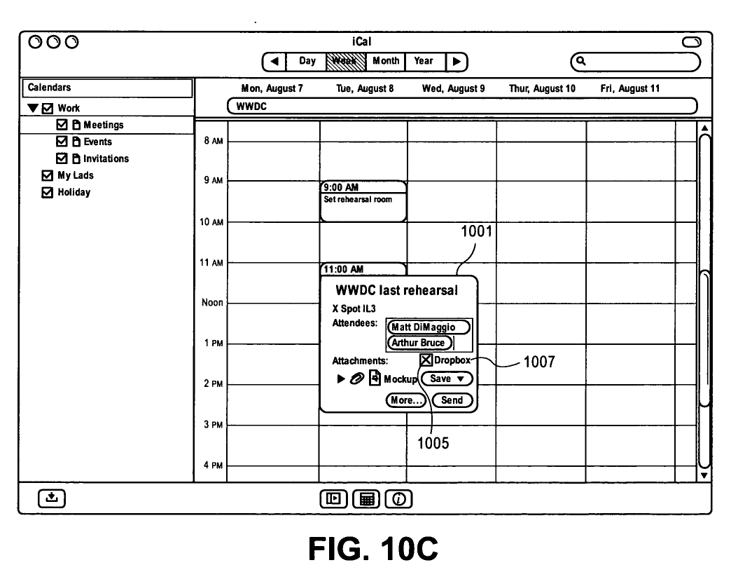

FIGS. 10A-C illustrate an alternate embodiment of a meeting event window 1001 that contains a checkbox 1005 with a “share” label 1007. The event organizer drags and drops files anywhere in the new event window 1001, and uses the checkbox 1005 to set the permissions for the drop box directory on the server. If the checkbox 1005 is left unchecked as shown in FIG. 10A, the attendees have read-only rights to the files. If the checkbox 1005 is checked by the organizer as shown in FIG. 10B, the attendees have read and write rights to the files. When the checkbox 1005 is checked, the client calendar application changes the label 1007 from “share” to “dropbox” as shown in FIG. 10C. Thus, the meeting invitation itself indicates to the attendee whether the attendee can add or modify files in the drop box. In one embodiment, if an attendee attempts to drag and drop files to the meeting event on the calendar and the checkbox 1005 is not checked, the client calendar application on the attendee's computer will ignore the files and/or notify the attendee that he/she does not have write permission.

If the user drops a virtual contact card (vCard) on the meeting event window 1001, a data detector is invoked to determine if the vCard is to be stored in the drop box or represents one of the attendees. In yet another embodiment, the meeting event window 1001 contains an “attachments” area 1003 that is a hot zone on which files are dropped that are to be stored in the drop box.

If the drop box for a reoccurring meeting event is being modified by the originator or an attendee, the calendar application on the client may present a dialog box 1100 as shown in FIG. 11. The data associated with the button selected by the user is used to modify the meeting invitation appropriately before it is sent to the calendar server.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer readable medium having embodied thereon executable program instructions that, when executed by a computer, cause the computer to perform operations comprising:
displaying a meeting event window within a calendar window, wherein files dropped on the meeting event window are received without opening a separate window;
determining that a file has been dropped on the meeting event window;
creating a meeting invitation containing a logical pointer to a copy of the file stored on a server; and
sending the meeting invitation to the server.

2. The computer readable medium of claim 1 further comprising:
copying the file to a directory, wherein the logical pointer is a directory path to a corresponding directory on the server that stores a copy of the file.

3. The computer readable medium of claim 2 further comprising:
creating the corresponding directory on the server; and
storing the copy of the file in the corresponding directory.

4. The computer readable of claim 2 further comprising:
setting permissions for attendees on the corresponding directory; and
denying access to the corresponding directory by an attendee based on the permissions.

5. The computer readable medium of claim 2 further comprising:
overwriting the copy of the file stored on the server when a modified version of the file is dropped on the meeting event window; and
sending a notification by the server that the meeting invitation has changed.

6. The computer readable medium of claim 5 further comprising:
retrieving the modified version of the file from the server in response to receiving the notification that the meeting invitation has changed.

7. The computer readable medium of claim 2 further comprising:
deleting the corresponding directory when an event associated with the meeting event window is cancelled.

8. The computer readable medium of claim 2 further comprising:
indicating attendee permissions on the corresponding directory in the meeting invitation; and
ignoring a file dropped on the meeting event window by an attendee if the attendee permission is read only.

9. The computer readable medium of claim 8, wherein the attendee permissions are indicated by a checkbox displayed in the meeting event window.

10. The computer readable medium of claim 1 further comprising:
specifying an area in the meeting event window for dropping files.

11. The computer readable medium of claim 1 further comprising:
indicating, in the meeting event window, directory permissions for attendees.

12. A computer implemented method comprising:
displaying a meeting event window within a calendar window, wherein files dropped on the meeting event window are received without opening a separate window;
determining that a file has been dropped on the meeting event window;
creating a meeting invitation containing a logical pointer to a copy of the file stored on a server; and
sending the meeting invitation to the server.

13. The computer implemented method of claim 12 further comprising:
copying the file to a directory, wherein the logical pointer is a directory path to a corresponding directory on the server that stores a copy of the file.

14. The computer implemented method of claim 13 further comprising:
creating the corresponding directory on the server; and
storing the copy of the file in the corresponding directory.

15. The computer implemented method of claim 13 further comprising:
setting permissions for attendees on the corresponding directory; and
denying access to the corresponding directory by an attendee based on the permissions.

16. The computer implemented method of claim 13 further comprising:
overwriting the copy of the file stored on the server when a modified version of the file is dropped on the meeting event window; and
sending a notification by the server that the meeting invitation has changed.

17. The computer implemented method of claim 16 further comprising:
retrieving the modified version of the file from the server in response to receiving the notification that the meeting invitation has changed.

18. The computer implemented method of claim 13 further comprising:
deleting the corresponding directory when an event associated with the meeting event window is cancelled.

19. The computer implemented method of claim 13 further comprising:
indicating attendee permissions on the corresponding directory in the meeting invitation; and
ignoring a file dropped on the meeting event window by an attendee if the attendee permission is read only.

20. The computer implemented method of claim 19, wherein the attendee permissions are indicated by a checkbox displayed in the meeting event window.

21. The computer implemented method of claim 12 further comprising:
specifying an area in the meeting event window for dropping files.

22. The computer implemented method of claim 12 further comprising:
indicating, in the meeting event window, directory permissions for attendees.

23. A data processing system comprising:
means for displaying a meeting event window within a calendar window, wherein files dropped on the meeting event window are received without opening a separate window;
means for determining that a file has been dropped on the meeting event window;
means for creating a meeting invitation containing a logical pointer to a copy of the file stored on a server; and
means for sending the meeting invitation to the server.

24. The data processing system of claim 23 further comprising:
means for copying the file to a directory, wherein the logical pointer is a directory path to a corresponding directory on the server that stores a copy of the file.

25. The data processing system of claim 23 further comprising:
means for creating the corresponding directory on the server; and
means for storing the copy of the file in the corresponding directory.

26. A machine readable medium containing executable program instructions which cause a data processing system to perform a method comprising:
displaying a hot zone in a calendar event window for an event creator;
associating a file dropped on the hot zone with the event; and
notifying an event attendee that the file is associated with the event, wherein the file is accessible by the event attendee through the notification.

27. The machine readable medium of claim 26, wherein the method further comprises:
setting permissions on the file as indicated by the event creator.

28. The medium readable medium of claim 26, wherein associating the file comprises:
creating metadata for at least one of the file and the event.

29. The machine readable medium of claim 26, wherein the method further comprises:
displaying the file separately from the calendar event window as a result of searching the metadata.

30. The machine readable medium of claim 29, wherein notifying the event attendee comprises:
displaying a file indicator on a calendar event window for the event attendee.

31. A machine implemented method comprising:
displaying a hot zone in a calendar event window for an event creator;
associating a file dropped on the hot zone with the event; and
notifying an event attendee that the file is associated with the event, wherein the file is accessible by the event attendee through the notification.

32. The machine implemented method of claim 31, wherein the method further comprises:
setting permissions on the file as indicated by the event creator.

33. The machine implemented method of claim 31, wherein associating the file comprises:
creating metadata for at least one of the file and the event.

34. The machine implemented method of claim 31, wherein the method further comprises:
displaying the file separately from the calendar event window as a result of searching the metadata.

35. The machine implemented method of claim 34, wherein notifying the event attendee comprises:
displaying a file indicator on a calendar event window for the event attendee.

36. A data processing system comprising:
means for displaying a hot zone in a calendar event window for an event creator;
means for associating a file dropped on the hot zone with the event; and
means for notifying an event attendee that the file is associated with the event, wherein the file is accessible by the event attendee through the notification.

37. A computer readable medium embodied with executable instructions to cause a processor to perform a method comprising:
receiving a copy of a file dropped on a meeting event window, wherein the file is stored in a directory on a client computer;
creating a corresponding directory on a server;
storing the copy of the file in the corresponding directory; and
sending a meeting invitation to attendees specified in the meeting event window.

38. The computer readable medium of claim 37, wherein the method further comprises:
setting permissions for the attendees on the corresponding directory; and
denying access to the corresponding directory by an attendee based on the permissions.

39. The computer readable medium of claim 37, wherein the method further comprises:
overwriting the copy of the file stored on the server when a modified version of the file is dropped on the meeting event window; and
sending a notification that the meeting invitation has changed.

40. The computer readable medium of claim 37, wherein the method further comprises:
deleting the corresponding directory when an event associated with the meeting event window is cancelled.

41. The computer readable medium of claim 37, wherein the method further comprises:
indicating attendee permissions on the corresponding directory in the meeting invitation; and
ignoring a file dropped on the meeting event window by an attendee if the attendee permission is read only.

42. A computer implemented method comprising:
receiving a copy of a file dropped on a meeting event window, wherein the file is stored in a directory on a client computer;
creating a corresponding directory on a server;
storing the copy of the file in the corresponding directory; and
sending a meeting invitation to attendees specified in the meeting event window.

43. The computer implemented method of claim 42 further comprising:
setting permissions for the attendees on the corresponding directory; and
denying access to the corresponding directory by an attendee based on the permissions.

44. The computer implemented method of claim 42 further comprising:
overwriting the copy of the file stored on the server when a modified version of the file is dropped on the meeting event window; and
sending a notification that the meeting invitation has changed.

45. The computer implemented method of claim 42 further comprising:
deleting the corresponding directory when an event associated with the meeting event window is cancelled.

46. The computer implemented method of claim 42 further comprising:
indicating attendee permissions on the corresponding directory in the meeting invitation; and
ignoring a file dropped on the meeting event window by an attendee if the attendee permission is read only.

47. A data processing system comprising:
means for receiving a copy of a file dropped on a meeting event window, wherein the file is stored in a directory on a client computer;
means for creating a corresponding directory on a server;
means for storing the copy of the file in the corresponding directory; and
means for sending a meeting invitation to attendees specified in the meeting event window.
